(19) United States
(12) Patent Application Publication
(10) Pub. No.: US 2026/0307081 A1
(43) Pub. Date: Oct. 8, 2026

(54) Agitator Mill and Method for Assembly and Dismantling a Grinding Vessel Bottom of an Agitator Mill

(71) Applicant: NETZSCH-Feinmahltechnik GmbH, Selb (DE)

(72) Inventors: Markus Nichterlein, Marktschorgast (DE); Thomas Goller, Schwarzenbach an der Saale (DE); Dennis Linberg, Waldsassen (DE)

(21) Appl. No.: 19/462,014

(22) Filed: Jan. 28, 2026

(30) Foreign Application Priority Data
Feb. 18, 2025 (DE) 10 2025 106 096.7

(51) Int. Cl. B02C 17/18; B02C 17/16

(52) U.S. Cl. CPC B02C 17/181; B02C 17/16

(57) ABSTRACT

An agitator mill including a grinding vessel and a stirring shaft extending in an axial direction inside the grinding vessel and mounted rotatably in the grinding vessel, with an additional bearing arranged outside the grinding vessel and braced with an axial end of the stirring shaft, a connecting flange arranged on a grinding vessel bottom extending in the direction of the additional bearing, wherein a through-hole is provided in the bottom of the grinding vessel and the through-hole and the connecting flange have an enlarged inner diameter compared to the additional bearing and wherein an adapter ring is provided, which can be inserted in an annular gap formed between the connecting flange and the bearing, which bridges the annular gap, and which can be connected to the connecting flange, and the additional bearing can be clamped via the adapter ring to the grinding vessel bottom in an installed state, as well as a method for assembly and dismantling a grinding vessel bottom in such an agitator mill.

### TECHNICAL FIELD

The present invention relates to an agitator mill and method for assembly and dismantling of a housing comprising a grinding stock inlet or outlet in an agitator mill.

### BACKGROUND

Agitator mills are used for fine and ultra-fine grinding of solids in liquids or dry materials. Conventional agitator mills comprise a grinding vessel in which a stirring shaft with grinding elements is arranged so as to be mounted rotatably. These grinding elements can be designed as fixed discs or movable grinding media and crush the grinding stock by means of impact, shear and frictional forces introduced into the grinding stock as the stirring shaft rotates. Agitator mills are used in various industries, for example for the fine grinding of cement components, crushing of ores and minerals, production of pigments, paints and varnishes, ultra-fine grinding of active agents in pharmaceutical production and the processing of for example, cocoa mass, spices or proteins in food technology. Agitator mills are filled with loose grinding media (e.g. balls or cylinders), which can move freely within the grinding vessel when filled. The stirring shaft sets the grinding media in motion, as a result of which the grinding stock is crushed by impact, friction and shear forces.

In large-scale agitator mills with long stirring shafts and great weight of the shaft, it is often necessary to mount an additional bearing position at the free end of the shaft outside the grinding vessel to prevent uncontrolled deflection of the shaft. In conventional designs, the further bearing is directly connected to the grinding vessel bottom, so that complete dismantling of the bearing is required to remove the inlet housing, in order for example to gain access to the interior of the grinding vessel for inspection or maintenance activities on the grinding elements. The disadvantage here is that the dismantling of the bearing is time-consuming, causes long downtimes, requires additional hoists or special devices for safe handling of the bearings, and carries the risk of damage to the bearing components due to repeated removal.

### SUMMARY

The problem of the present invention, therefore, is to provide a possibility for simplified access to the interior of a grinding vessel.

According to the invention, this problem is solved in each case by the subject matter of the claims.

According to a first aspect of the invention, an agitator mill comprising a grinding vessel and a stirring shaft extending in an axial direction within the grinding vessel and mounted rotatably in the grinding vessel, with an additional bearing arranged outside the grinding vessel and braced with an axial end of the stirring shaft, and a connecting flange extending in the direction of the additional bearing and arranged on a grinding vessel bottom. A through-hole is provided in the bottom of the grinding vessel, wherein the through-hole and the connecting flange have an enlarged inner diameter compared to the additional bearing and an adapter ring is provided which can be inserted in an annular gap between the connecting flange and the bearing, which bridges the annular gap and which can be connected to the connecting flange, and the additional bearing is clamped to the grinding vessel bottom in an installed state via the adapter ring.

According to a second aspect of the invention, a method for dismantling a grinding vessel bottom in the agitator mill according to the invention is provided. The method includes loosening and removal of the clamping ring; loosening and removal of the adapter ring; and stripping the grinding vessel bottom over the additional bearing.

According to a third aspect of the invention, a method for mounting a grinding vessel bottom in the agitator mill according to the invention is provided. The method includes: Sliding the grinding vessel bottom over the additional bearing until the grinding vessel bottom reaches an installation position on the grinding vessel, aligning and connecting the grinding vessel bottom with the grinding vessel, inserting the adapter ring into the annular gap and centring of the additional bearing and the stirring shaft by fixing the adapter ring on the connecting flange; and positioning the clamping ring and screwing the clamping ring to the adapter ring and the additional bearing, in particular to a bearing flange provided at the periphery on the additional bearing.

An idea underlying the present invention is to avoid the dismantling of an additional bearing located at the free end of the shaft, in particular in a large-scale agitator mill, in that the bearing is no longer connected directly to the grinding vessel bottom, but instead is clamped via an adapter ring and a clamping ring to the grinding vessel bottom via the connecting flange arranged thereon. The fact that the through-hole has a larger inner diameter than the outer diameter of the bearing creates an annular gap, which is closed by the adapter ring when installed. During assembly or dismantling of the grinding vessel bottom, an opening with a greater clear width than the diameter of the bearing is created by the annular gap, so that the bottom of the grinding vessel can be guided over the bearing and so an access to the grinding chamber is enabled. The annular gap is dimensioned in such a way that it is still possible to strip the bottom of the grinding vessel even if the bearing, which is no longer supported in the connecting flange, is deflected. This simplifies access to the interior of the grinding vessel, for example for maintenance and inspection purposes, without the additional bearing of the mill having to be dismantled. This is advantageous particularly in the case of large-scale grinding devices, since there is no need, among other things, to use hoists to dismantle the heavy bearings. Furthermore, assembly and dismantling is simplified if the grinding vessel bottom is combined with a platform as a unit, which is designed to be movable relative to the grinding vessel during dismantling or assembly. In addition to the shortening of the work routines, the service life of the bearing is extended by firm clamping of the bearing to the shaft and the avoidance of repeated installation and dismantling. Misalignments that can occur during repeated assembly can also be avoided by the centring action of the adapter ring. Since the adapter ring has a conical centring section, a precise alignment of the stirring shaft and the additional bearing is advantageously enabled during assembly. Although the advantages of the agitator mill according to the invention arise primarily in connection with large-scale agitator mills with long stirring shafts, for example in the cement or mining industries, the agitator mill designed according to the invention can however also be scaled for other mill sizes and applications and can for example also be designed as a smaller mill in the food and pharmaceutical industries or as a laboratory mill. The methods according to the invention advantageously enable an orderly and fast assembly or dismantling in a few steps, wherein the bottom of the grinding vessel is simply pushed away over the additional bearing, which remains connected to the shaft.

Advantageous embodiments and developments result from the sub-claims related back to the independent claims as well as from the description making reference to the figures.

According to an embodiment, a housing arranged between the grinding vessel bottom and the additional bearing is provided on the grinding vessel bottom. The through-hole extends from the bottom of the grinding vessel through the housing and the connecting flange is arranged at an outer side of the housing facing the bearing, wherein the additional bearing is clamped in the installed state via the adapter ring to the housing. For assembly or dismantling, the housing does not have to be dismantled separately but can be pulled over the bearing in the same way as and together with the bottom of the grinding vessel.

According to an embodiment, a clamping ring is provided, wherein the clamping ring is screwed in the installation state to the adapter ring and the additional bearing, in particular to a flange provided at the periphery on bearing. By screwing the clamping ring to the adapter ring and the bearing flange, a stable and form-fitting connection is created, which ensures reliable power transmission between the components. The clamping ring also enables easy separation of the connection between the bearing and the adapter ring, so that the annular gap, which is open after removal of the adapter ring, enables stripping of the grinding vessel bottom or grinding vessel bottom and housing from the bearing or stirring shaft.

According to a development, the clamping ring is formed from several independent clamping ring segments. The clamping ring segments are screwed in the installed state to the adapter ring and the additional bearing, in particular to a bearing flange provided at the periphery on the bearing. Since the clamping ring segments can be mounted and released individually, this eliminates the need to slide a complete, closed clamping ring over the shaft or bearing. This enables dismantling in steps. The clamping ring segments can be fitted and adjusted individually, as a result of which uniform bracing is advantageously achieved with the adapter ring and the bearing flange.

According to an embodiment, the adapter ring has a conical centring section, which can be inserted between the additional bearing and the connecting flange and centres the additional bearing relative to the connection flange. By means of the conical centring section, the additional bearing is aligned automatically, in a position-precise manner and reproducibly relative to the connecting flange and misalignments are prevented. The adapter ring with conical section also facilitates axial insertion of the bearing into the installation position, since it automatically slides or pulls it into the correct position by the cone effect.

According to a development, at least one load-bearing support means that can be engaged with the additional bearing is provided. The support means can be designed as a hydraulically or pneumatically actuated lifting cylinder, support strut or punch that can be moved in the direction of the bearing, which is connected or can be connected to the bottom of the grinding vessel, the housing or a housing base. The support means can also be provided, integrated into a platform of the agitator mill or, if necessary, arranged under the bearing or a support point. During dismantling, the support means advantageously removes a part of the bending forces acting on the stirring shaft, as a result of which the mechanical load on the stirring shaft is reduced. Instead of a support means as described above, suspension points, such as eyelets or hooks, can also be provided at the bearing for connection to a hoist arranged above the bearing.

According to a development of the method for the dismantling, a housing comprising a grinding stock inlet or outlet, which can be arranged between the grinding vessel bottom and the additional bearing, is provided. When stripping the grinding vessel bottom, the grinding vessel bottom and the housing that can be arranged thereon can thus be stripped over the additional bearing. This advantageously speeds up dismantling, since the housing can also be guided over the bearing. Of course, the grinding vessel bottom and housing can also be guided separately from each other, one after the other, over the bearing.

According to a development of the method for dismantling, the clamping ring is formed from several independent clamping ring segments, and a successive loosening and removal of the individual clamping ring segments is provided when the clamping ring is loosened and removed. Due to the segmented design, the clamping ring can be removed piece by piece. Since the individual clamping ring segments are released one after the other, a time-consuming or simultaneous lifting of the entire clamping ring is not necessary, which eliminates the use of additional hoists or special tools, especially in large-scale systems. When a conventional, one-piece clamping ring is loosened at the same time, uneven stresses can act on the bearing and the adapter ring, so that the risk of stressing is advantageously reduced by the successive dismantling of the segments.

According to a development of the method for the dismantling, an engagement of the load-bearing support means with the additional bearing is provided before or after the loosening and removal of the clamping ring or the clamping ring segments and the adapter ring. The support means advantageously removes a part of the load of the additional bearing and prevents jamming of the bearing or shaft during dismantling. In addition, bending forces acting on the shaft are reduced. Especially in the case of large-scale agitator mills with heavy bearings, the support means enables controlled dismantling, since the support of the bearing prevents or reduces a free cantilever, combined with the introduction of corresponding bending forces into the shaft. Alternatively, the suspension of the bearing on a hoist can also be provided.

According to a development of the method for the assembly, a housing comprising a grinding stock inlet or outlet, which can be arranged between the bottom of the grinding vessel and the additional bearing is provided. When the bottom of the grinding vessel is pushed open, the bottom of the grinding vessel and the housing that can be arranged thereon is pushed open over the additional bearing until an installation position of the grinding vessel bottom of the grinding vessel is reached. This speeds up the assembly, since the bottom of the grinding vessel and the housing that can be arranged thereon can be guided over the bearing as a unit. Of course, the grinding vessel bottom and housing can also be guided over the bearing one after the other, wherein the bearing is then clamped to the housing.

According to a development of the method of assembly, the clamping ring is formed from several independent clamping ring segments. When positioning the clamping ring and screwing the clamping ring to the adapter ring and the additional bearing, successive placement and screwing of the individual clamping ring segments is provided. During assembly, the same advantages arise as those that have already been carried out in connection with dismantling,

According to a development of the method of assembly, the centring of the additional bearing and the stirring shaft relative to the grinding vessel flange is carried out by the conical centring section of the adapter ring. The conical centring section of the adapter ring ensures that the additional bearing and the stirring shaft automatically move or are pulled into the assembly position. Manual adjustments are thus advantageously avoided. Due to the precise centring, an even distribution of force is also ensured, as a result of which the load on the bearing, adapter ring and grinding vessel flange is minimised.

According to a development of the method of assembly, engagement of the load-bearing support means with the additional bearing is provided before the insertion of the adapter ring. The support means advantageously removes part of the load of the additional bearing and prevents the bearing or shaft from jamming during the assembly and supports centring. Especially in large-scale agitator mills with heavy bearings, the support means enables controlled assembly, since the support of the bearing prevents or reduces a free cantilever, combined with the introduction of corresponding bending forces into the shaft. Alternatively, the suspension of the bearing can also be provided on a hoist.

The above embodiments and developments can be combined arbitrarily with one another, insofar as feasible. Further possible embodiments, developments and implementations of the invention also include combinations of not explicitly mentioned features of the invention that are described previously or subsequently with regard to the examples of embodiment. In particular, the person skilled in the art will also add individual aspects as improvements or additions to the respective basic form of the present invention.

### BRIEF DESCRIPTION OF THE DRAWINGS

The present invention is explained in greater detail below using examples of embodiment making reference to the appended figures in the drawings.

In the figures:

FIG. 1 shows a diagrammatic representation of a detail of an agitator mill according to an example of embodiment of the invention;

FIG. 2 shows a lateral cross-sectional representation of an agitator mill according to an example of embodiment of the invention, and;

FIG. 3 shows a cross-sectional representation of an agitator mill according to an example of embodiment of the invention.

In the figures of the drawing, identical, functionally identical or identically acting elements, features and components-insofar as not otherwise stated-are each provided with the same reference number.

### DETAILED DESCRIPTION

Although specific embodiments and developments are represented and described in the present case, the person skilled in the art will prefer that a plurality of alternative and/or similar embodiments can replace the represented and described specific embodiments, without departing from the scope of the present invention. In general, this application is intended to cover all modifications or changes to the specific embodiments described herein.

The appended figures are intended to provide a further understanding of embodiments of the invention and serve in connection with the description of the explanation of principles and concepts of the invention. Other examples of embodiment and many of the advantages mentioned arise with regard to the drawings. The drawings are only to be understood as diagrammatic drawings and the elements of the drawings are not necessarily shown true to scale with respect to each other. Directional terminology such as “up”, “down”, “left”, “right”, “above”, “below”, “horizontal”, “vertical”, “front”, “back” and similar indications are used only for explanatory purposes and do not serve to restrict the generality to specific embodiments as shown in the figures.

Dashed lines in the figures of the drawings make it clear that the connections between the components connecting the dashed lines do not necessarily have to have physical contact with each other but can also be wirelessly coupled to each other.

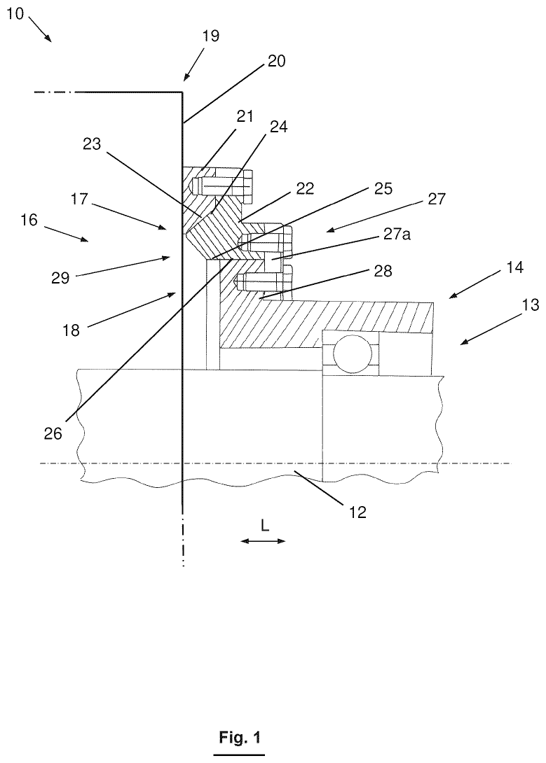

FIG. 1 shows a diagrammatic representation of a detail of an agitator mill 10 according to an example of an embodiment of the invention. Agitator mill 10 comprises a grinding vessel 11, which is not shown in FIG. 1, in which a rotatably mounted stirring shaft 12 extending along the longitudinal axis L of grinding vessel 11 is arranged. Stirring shaft 12 projects beyond grinding chamber 30, not shown in FIG. 1, in the longitudinal direction. Axial end 13 of stirring shaft 12 is braced with an additional bearing 14 arranged outside grinding vessel 11. In the example of embodiment, grinding vessel bottom 15, not shown, is connected to a housing 19 surrounding a grinding stock inlet or outlet, which adjoins bottom 15 of the grinding vessel in the axial direction and is connected thereto. Housing 19 comprises connecting flange 21 extending in the direction of additional bearing 14. A through-hole 16, through which the stirring shaft is passed into grinding chamber 30, extends between bottom 15 of the grinding vessel and housing 19. Through-hole 16, like connecting flange 21, has an inner diameter 17 that is larger than the outer diameter 18 of the additional bearing 14. Connecting flange 21 is attached to outer side 20 of housing 19 and surrounds through-hole 16. An adapter ring 22 is inserted between connecting flange 21 and additional bearing 14. Adapter ring 22 is screwed to connecting flange 21. Adapter ring 22 is provided with a conical centring section 23, which abuts against a surface 24 of connecting flange 21 inclined towards adapter ring 22. A flat inner perimeter area 25 of adapter ring 22 lies in the assembled state on outer circumferential surface 26 of bearing 14. Conical centring section 23 is designed in such a way that it displays a self-centring effect during assembly and guides additional bearing 14 into an exact position relative to connecting flange 21. The conical shape allows the bearing 14 to be pulled automatically through adapter ring 22 into the correct position during assembly, so that misalignments are avoided. In addition, the conical design facilitates the insertion of adapter ring 22, since the latter is positioned axially on bearing 14 when the screwing is tightened and creates an even contact surface and at the same time is pulled into connecting flange 21.

Adapter ring 22 is screwed via a clamping ring 27, formed from a plurality of independent clamping ring segments 27a, to bearing flange 28 provided at the periphery on bearing 14 on the one hand and adapter ring 22 on the other. Split clamping ring 27 secures the connection between adapter ring 22 and bearing flange 28, so that additional bearing 14 is fixed axially in a stable manner. An annular gap 29 is provided between connecting flange 21 and additional bearing 14, which is bridged by adapter ring 22 when assembled. Annular gap 29 is dimensioned in such a way that its gap width when the adapter ring 22 is removed is greater than the extent of a lowering of bearing 14 caused by a deflection of the stirring shaft 12. Even when adapter ring 22 is removed, the bearing cannot lie on through-hole 16. The clear width of annular gap 29 thus makes it possible, after removal of adapter ring 22, to move housing 19 and grinding vessel bottom 15 connected to it in an axial direction over the bearing 14, i.e. to displace it in an axial direction without having to remove bearing 14 from stirring shaft 12. During dismantling of housing 19, split clamping ring 27 is first loosened and removed. Then adapter ring 22 is removed, as a result of which annular gap 29 is freed. This allows access to the interior of grinding vessel 11, without the need for a complex dismantling of the additional bearing 14.

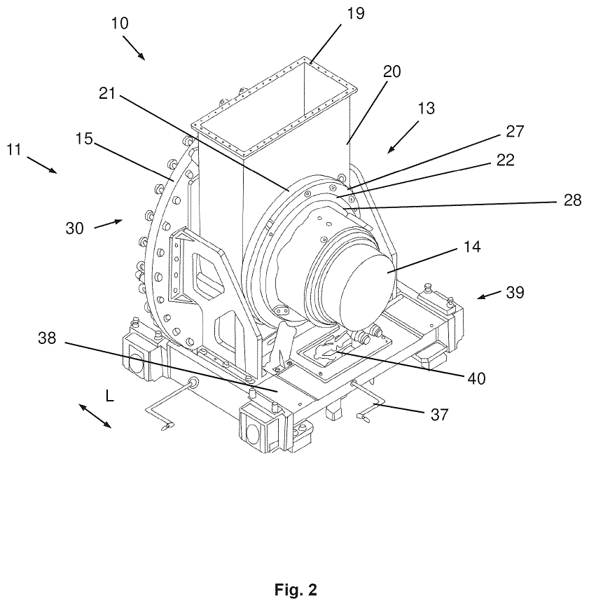

FIG. 2 shows a lateral cross-sectional representation of an agitator mill 10 according to an example of embodiment of the invention. Agitator mill 10 comprises a stirring shaft 12 extending along longitudinal axis L, which is mounted rotatably inside grinding vessel 11. Stirring shaft 12 is supported in at least one further bearing 31 (not shown in FIG. 2). At free axial end 13 of stirring shaft 12, which projects beyond grinding vessel 11, an additional bearing 14 is arranged outside grinding vessel 11, which serves to stabilize stirring shaft 12 and prevents uncontrolled deflection. Additional bearing 14 is clamped to stirring shaft 12 and is clamped via an adapter ring 22 and a split clamping ring 27 to connecting flange 21 of housing 19, arranged in the example of embodiment on grinding vessel bottom 15, in the example of embodiment an inlet housing for grinding stock. Housing 19 enables the controlled feeding of the grinding stock into grinding vessel 11, where it is crushed by the grinding media located in grinding chamber 30 when stirring shaft 12 rotates.

As described in connection with FIG. 1, adapter ring 22 has a conical centring portion 23, which lies between additional bearing 14 and connecting flange 21 arranged on outer side 40 of housing 19 and centres bearing 14 relative to connecting flange 21. An annular gap 29 is provided between additional bearing 14 and connecting flange 21, the clear width of which is dimensioned in such a way that housing 19 and grinding vessel bottom 15 connected thereto can be moved away along longitudinal axis L over additional bearing 14 without collision. This enables dismantling of housing 19 and grinding vessel bottom 15 without removing additional bearing 14, so that for example maintenance or inspection work can be carried out on stirring elements 32 in the interior of grinding vessel 11.

Stirring shaft 12 extends through entire grinding vessel 11 and comprises an outlet housing 34 and a separating means 35 provided in grinding vessel 11 at a second end 33 opposite additional bearing 14. Separating means 35 is used for the separation of grinding media (not shown) from the grinding stock flow before the latter leaves grinding vessel 11 via outlet housing 34. Stirring shaft 12 is connected to a drive not shown in FIG. 2, which produces the rotational motion required for the grinding process. The drive can for example be an electric motor which is connected to stirring shaft 12 via a clutch or gearbox. Unit 39, which consists of housing 19 and grinding vessel bottom 15, is fastened in the example of embodiment of FIG. 2 on a platform 38, which can be moved in longitudinal direction L relative to grinding vessel 11. This platform 38 also holds support element 40, which is designed as a punch provided to support bearing 14 during assembly or dismantling, which is arranged height-adjustable on bearing 14 via a crank drive 37 or can be lowered from the latter.

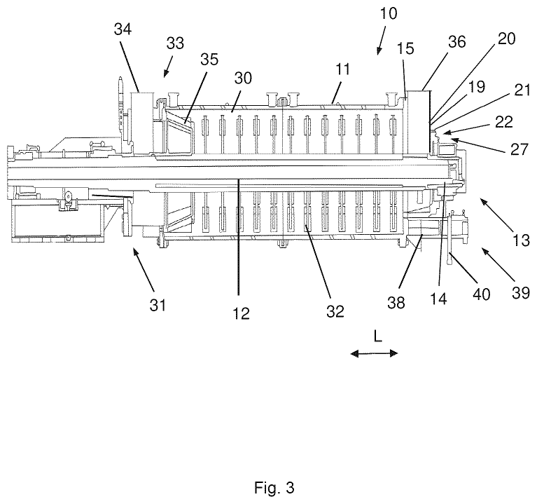

FIG. 3 shows a cross-sectional representation of an agitator mill 10 according to an example of embodiment of the invention. The illustration shows grinding vessel bottom 15, which is screwed to grinding vessel 11 when agitator mill 10 is assembled and closes it. Grinding vessel bottom 15 is removable together with housing 19 arranged thereon, in order to gain access to the interior of the grinding vessel, for example for maintenance or inspection work on stirring elements 32.

In the example of embodiment shown, housing 19 serves as an inlet housing for the grinding stock. Housing 19 extends axially over free axial end 13 of stirring shaft 12 and enables the regulated feeding of the grinding stock into grinding vessel 11. Housing 19 is provided with a rectangular opening 36 for receiving the grinding stock and is connected to grinding vessel bottom 15 by means of flange connections not shown in FIG. 3.

Also shown is additional bearing 14, which is braced with stirring shaft 12 and provided axially downstream of housing 19. Stirring shaft 12 is mounted in at least one further bearing assigned to grinding vessel 11. An adapter ring 22 is provided for fixing additional bearing 14 and is screwed to connecting flange 21, which is arranged on outer side 20 of housing 19. For additional securing, a split clamping ring 27 is available, which connects bearing 14 to adapter ring 22. In order, for the purpose of dismantling, to be able to guide housing 19 and grinding vessel bottom 15 over bearing 14, the screws of clamping ring segments 27a of clamping ring 27 are first loosened and clamping ring segments 27a are removed from adapter ring 22 and bearing flange 28 (see FIG. 1), in order to loosen the connection between adapter ring 22 and additional bearing 14. Adapter ring 22 is next removed from its clamping position on connecting flange 21, so that annular gap 29 between additional bearing 14 and connecting flange 21 is freed. After loosening the connection between grinding vessel bottom 15 and grinding vessel 11, housing 19 together with grinding vessel bottom 15 can be pulled away over additional bearing 14. Before removing adapter ring 22, a support means 40 arranged centrally below bearing 14 in a platform 38 can be moved in the direction of bearing 14 and engaged with bearing 14 in order to remove occurring bending loads and to keep bearing 14 in a horizontal position. In the example of embodiment, support means 40 is designed as a punch, which is also height-adjustable by means of manual crank drive 37 (see FIG. 2), which is also installed in platform 38 and can be placed onto bearing 14. Grinding vessel bottom 15 and housing 19 can also be firmly connected to the platform combined in a unit 39 movable relative to grinding vessel 11. For removal, this unit is moved over bearing 14 and makes grinding chamber 11 accessible without bearing 14 having to be dismantled from agitator shaft 12.

In the preceding detailed description, various features have been summarised in one or more examples for the improvement of the stringency of the presentation. It should be clear, however, that the above description is merely illustrative, but by no means of a restrictive nature. It serves to cover all alternatives, modifications and equivalents of the various features and examples of embodiment. Many other examples will be immediately and directly become clear to the person skilled in the art on account of his technical knowledge in view of the above description.

The examples of embodiment have been selected and described in order to be able to present the principles underlying the invention and its possible applications in practice in the best possible way. Persons skilled in the art are thus able to modify and use the invention and its various examples of embodiment in the optimum manner in relation to the intended use. In the claims and the description, the terms “containing” and “comprising” are used as neutral linguistic terms for the corresponding terms “including”. Furthermore, the use of the term “a” should not fundamentally exclude a plurality of such described features and components.

1. An agitator mill with a grinding vessel and a stirring shaft mounted rotatably in the grinding vessel extending in the axial direction inside the grinding vessel, with an additional bearing arranged outside the grinding vessel and braced with an axial end of the stirring shaft, a connecting flange extending in the direction of the bearing arranged on a grinding vessel bottom, wherein the through-hole is provided in the grinding vessel bottom and the through-hole and the connecting flange have an increased inner diameter compared to the additional bearing and wherein an adapter ring is provided, which can be inserted in a annular gap formed between the connecting flange and the bearing, which bridges the annular gap and which can be connected to the connecting flange, and the additional bearing formed between the connecting flange and the additional bearing can be clamped to the grinding vessel bottom when installed via the adapter ring.

2. The agitator mill according to claim 1, wherein a housing, which can be arranged between the grinding vessel bottom and the additional bearing, is provided on the grinding vessel bottom and the through-hole extends from the grinding vessel bottom through the housing and the connecting flange is arranged on an outer side of the housing facing the bearing, and wherein the additional bearing can be clamped when installed via the adapter ring to the housing.

3. The agitator mill according to claim 1, wherein a clamping ring is provided, wherein the clamping ring can be screwed when installed to the adapter ring and the additional bearing, in particular to a bearing flange provided at the periphery on the additional bearing.

4. The agitator mill according to claim 3, wherein the clamping ring is formed from several independent clamping ring segments and the clamping ring segments can be screwed when installed to the adapter ring and the additional bearing, in particular to a bearing flange provided at the periphery of the additional bearing.

5. The agitator mill according to claim 1, wherein the adapter ring comprises a conical centring section, which can be inserted between the additional bearing and the connecting flange and which centres the additional bearing relative to the connecting flange.

6. The agitator mill according to claim 1, wherein at least one load-bearing supporting means is provided, which can be engaged with the additional bearing.

7. A method for dismantling a grinding vessel bottom of an agitator mill with a grinding vessel and a stirring shaft mounted rotatably in the grinding vessel extending in the axial direction inside the grinding vessel, with an additional bearing arranged outside the grinding vessel and braced with an axial end of the stirring shaft, a connecting flange extending in the direction of the bearing arranged on a grinding vessel bottom, wherein the through-hole is provided in the grinding vessel bottom and the through-hole and the connecting flange have an increased inner diameter compared to the additional bearing and wherein an adapter ring is provided, which can be inserted in a annular gap formed between the connecting flange and the bearing, which bridges the annular gap and which can be connected to the connecting flange, and the additional bearing formed between the connecting flange and the additional bearing can be clamped to the grinding vessel bottom when installed via the adapter ring, the method comprising the steps of:
loosening and removal of the clamping ring;
loosening and removal of the adapter ring; and
stripping the of the grinding vessel bottom over the additional bearing.

8. The method for dismantling a grinding vessel bottom of an agitator mill according to claim 7, wherein a housing, which can be arranged between the grinding vessel bottom and the additional bearing, which comprises a grinding stock inlet or outlet, is provided and, during stripping the grinding vessel bottom, the grinding vessel bottom and the housing that can be arranged thereon is stripped over the additional bearing.

9. The method for dismantling a grinding vessel bottom of an agitator mill according to claim 7, wherein the clamping ring is formed from several independent clamping ring segments and, during loosening and removing the clamping ring, a successive loosening and removal of the individual clamping ring segments is provided.

10. The method for dismantling a grinding vessel bottom of an agitator mill according to claim 7, wherein prior to the loosening of the adapter ring, an engagement of the load-bearing support means with the additional bearing is provided.

11. A method for assembly of a grinding vessel bottom of an agitator mill with a grinding vessel and a stirring shaft mounted rotatably in the grinding vessel extending in the axial direction inside the grinding vessel, with an additional bearing arranged outside the grinding vessel and braced with an axial end of the stirring shaft, a connecting flange extending in the direction of the bearing arranged on a grinding vessel bottom, wherein the through-hole is provided in the grinding vessel bottom and the through-hole and the connecting flange have an increased inner diameter compared to the additional bearing and wherein an adapter ring is provided, which can be inserted in a annular gap formed between the connecting flange and the bearing, which bridges the annular gap and which can be connected to the connecting flange, and the additional bearing formed between the connecting flange and the additional bearing can be clamped to the grinding vessel bottom when installed via the adapter ring, the method comprising the steps of:
sliding the grinding vessel bottom over the additional bearing until an installation position of the grinding vessel bottom on grinding vessel is reached,
alignment and connection of the grinding vessel bottom with the grinding vessel,
insertion of the adapter ring into the annular gap and centring of the additional bearing and the stirring shaft by fixing the adapter ring to the connecting flange; and
positioning of the clamping ring and screwing the clamping ring to the adapter ring and the additional bearing, in particular to a bearing flange provided at the periphery of the additional bearing.

12. The method for assembly of a grinding vessel bottom of an agitator mill according to claim 11, wherein a housing is provided, which can be arranged between the grinding vessel bottom and the additional bearing and which comprises a grinding stock inlet or outlet and, when sliding of grinding vessel bottom takes place, provision is made such that sliding of grinding vessel bottom and the housing that can be arranged thereon takes place over the additional bearing until an installation position of the grinding vessel bottom is reached on the grinding vessel.

13. The method for assembly of a grinding vessel bottom of an agitator mill according to claim 11, wherein the clamping ring is formed from several independent clamping ring segments and, when the clamping ring is positioned and the clamping ring is screwed to the adapter ring and the additional bearing, provision is made for the individual clamping ring segments to be successively positioned and screwed.

14. The method for assembly of a grinding vessel bottom of an agitator mill according to claim 11, wherein the centring of the additional bearing and the stirring shaft relative to the connecting flange takes place by means of the conical centring section of the adapter ring.

15. The method for assembly of a grinding vessel bottom of an agitator mill according to claim 11, wherein prior to the insertion of the adapter ring, an engagement of the load-bearing support means with the additional bearing is provided.

16. The agitator mill according to claim 2, wherein a clamping ring is provided, wherein the clamping ring can be screwed when installed to the adapter ring and the additional bearing, in particular to a bearing flange provided at the periphery on the additional bearing.

17. The agitator mill according to claim 2, wherein the adapter ring comprises a conical centring section, which can be inserted between the additional bearing and the connecting flange and which centres the additional bearing relative to the connecting flange.

18. The agitator mill according to claim 2, wherein at least one load-bearing supporting means is provided, which can be engaged with the additional bearing.

19. The method for dismantling a grinding vessel bottom of an agitator mill according to claim 8, wherein the clamping ring is formed from several independent clamping ring segments and, during loosening and removing the clamping ring, a successive loosening and removal of the individual clamping ring segments is provided.

20. The method for assembly of a grinding vessel bottom of an agitator mill according to claim 12, wherein the clamping ring is formed from several independent clamping ring segments and, when the clamping ring is positioned and the clamping ring is screwed to the adapter ring and the additional bearing, provision is made for the individual clamping ring segments to be successively positioned and screwed.
